(19) United States
(12) Patent Application Publication
(10) Pub. No.: US 2022/0237503 A1
(43) Pub. Date: Jul. 28, 2022

(54) MACHINE LEARNING MODEL DEPLOYMENT WITHIN A DATABASE MANAGEMENT SYSTEM

(71) Applicant: International Business Machines Corporation, Armonk, NY (US)

(72) Inventors: CARLO APPUGLIESE, Seminole, FL (US); Dheeraj Arremsetty, Austin, TX (US); Ravikumar Govindan, Wildwood, MO (US); Rakshith Dasenahalli Lingaraju, Palo Alto, CA (US); Timothy Thomas Bohn, Ventura, CA (US); Shaikh Shahriar Quader, Scarborough (CA); Carmen-Gabriela Stefanita, Boston, MA (US); Ingo Schuster, Tuebingen (DE)

(73) Assignee: International Business Machines Corporation, Armonk, NY (US)

(21) Appl. No.: 17/158,184

(22) Filed: Jan. 26, 2021

(51) Int. Cl. G06N 20/00

(52) U.S. Cl. CPC G06N 20/00

(57) ABSTRACT

Model data comprising a model object and model metadata is extracted from a trained model. The model data is integrated within a function executable from within a database system environment. The integrated function is deployed within the database system environment, the deploying activating the trained model for execution within the database system environment.

### BACKGROUND

The present invention relates generally to a method, system, and computer program product for machine learning model deployment. More particularly, the present invention relates to a method, system, and computer program product for machine learning model deployment within a database management system.

A database is an organized collection of data, generally stored and accessed electronically from a computer system. A relational database is a database that presents data to a user as a set of relations (i.e. as a collection of tables with each table comprising a set of rows and columns) and provides relational operators to manipulate the data in tabular form. A database management system (DBMS) is software that interacts with end users, applications, and data in the database to collect, store, organize, and analyze data, and administer the database and associated applications that interface with the database. A DBMS and a database managed by the DBMS constitute a database system environment. A relational DBMS is a DBMS that manages a relational database. Structured Query Language (SQL) is a programming language often used for managing data held in a database, particularly a database managed by a relational DBMS, because SQL was specifically designed to query data in a database. SQL implementations are often incompatible between vendors and do not necessarily completely follow standards. Thus, as used herein, SQL includes database query language implementations that support all or part of the SQL standard, as well as SQL-related programming languages that include SQL-like capabilities and support SQL-like syntax.

A machine learning model is the output of a machine learning algorithm run on data and represents what was learned by a machine learning algorithm. Thus, a machine learning model is a collection of data, such as rules, numbers, and any other algorithm-specific data structures, that describes the model sufficiently for model use. Typically, a machine learning model is trained on a set of training data before being put into use to process non-training data. However, some machine learning models are retrained or updated periodically once initial model training is complete. Scoring a machine learning model refers to the output of the model, for example a prediction, classification, or score value.

### SUMMARY

The illustrative embodiments provide a method, system, and computer program product. An embodiment includes a method that extracts, from a trained model, model data, the model data comprising a model object and model metadata. An embodiment integrates, within a function executable from within a database system environment, the model data. An embodiment deploys, within the database system environment, the integrated function, the deploying activating the trained model for execution within the database system environment.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for machine learning model deployment within a database management system in accordance with an illustrative embodiment;

FIG. 4 depicts an example of machine learning model deployment within a database management system in accordance with an illustrative embodiment;

FIG. 5 depicts a continued example of machine learning model deployment within a database management system in accordance with an illustrative embodiment;

FIG. 6 depicts a continued example of machine learning model deployment within a database management system in accordance with an illustrative embodiment;

FIG. 7 depicts a flowchart of an example process for machine learning model deployment within a database management system in accordance with an illustrative embodiment;

FIG. 8 depicts a cloud computing environment according to an embodiment of the present invention; and

FIG. 9 depicts abstraction model layers according to an embodiment of the present invention.

### DETAILED DESCRIPTION

The illustrative embodiments recognize that database system environments typically lack support for the programming languages, existing libraries and programming tools, and model training environments that are commonly used in developing machine learning models. Thus, there is a need to develop and train machine learning models outside a database system environment.

However, the illustrative embodiments also recognize that developing and training machine learning models outside a database system environment requires that data managed by a DBMS be sent outside a database system environment to an externally-hosted model for processing, and the resulting data be returned to the database system environment for storage and further analysis. Exporting data from the database system environment increases data processing, storage, and monitoring costs, increases time spent processing data through the model, and could comprise the security of the data being exported. The greater the amount of data to be processed by the model, the more time is spent transferring the data across a network to the model and transferring the model's output back to the database system environment. In addition, using an externally-hosted model requires a different set of skills from that already possessed by most business analysts and other experienced DBMS users. For example, an externally-hosted model might not be query-able using SQL queries most business analysts are accustomed to using when manipulating data within a database. As well, existing analytical tools such as dashboards, insight tools, and report creators, designed to process data managed by a DBMS, cannot be used to access the output of an externally-hosted machine learning model until the model's output is returned to the database. As a result, externally-hosted machine learning models are difficult for business analysts and other users who are not data scientists or machine learning experts to use. As well, because the models are difficult to use, they are often underused. Thus, the illustrative embodiments recognize that there is an unmet need to integrate an externally-trained machine learning model within a database system environment, allowing user to use the model using existing SQL queries and analytical tools and avoiding export of data from the DBMS.

The illustrative embodiments recognize that the presently available tools or solutions do not address these needs or provide adequate solutions for these needs. The illustrative embodiments used to describe the invention generally address and solve the above-described problems and other problems related to machine learning model deployment within a database management system.

An embodiment can be implemented as a software application. The application implementing an embodiment can be configured as a modification of an existing DBMS, as a separate application that operates in conjunction with an existing DBMS, a standalone application, or some combination thereof.

Particularly, some illustrative embodiments provide a method that extracts model data from a trained model, integrates the model data within a function executable from with a database system environment, and deploys the integrated function within the database system environment, activating the trained model for execution within the database system environment.

An embodiment begins with an already-trained model. One method of generating a trained model is to export a subset of data from a database for use as training and validation data and using the exported data to train and validate the model using any presently available model training technique. Model training and validation outside a database system environment allows for model development, training, and validation in an environment best suited to such activities, providing the ability to configure and train complex models and training efficiency.

An embodiment extracts model data from the already-trained model. The model data is data describing the model sufficiently for model use within a database system environment. The model data includes both the model object, used to generate a score from model inputs, and model metadata, which describes any data pre-processing needed to execute the model object. Machine learning models are commonly implemented in a pipeline configuration, in which data pre-processing or feature engineering steps are performed in series, followed by generating a score. In one embodiment, the model metadata describes feature scaling, including normalization and standardization, of data input to the model. Feature scaling is often needed when the values of numeric columns in the dataset are to be changed to a common scale, without distorting differences in the ranges of values or losing information. Normalization results in rescaled data falling in a range between zero and one. Standardization results in the rescaled data having properties of a normal standard distribution with a mean equal to zero and a standard deviation equal to one. In another embodiment, the model metadata describes data needed for principal component analysis, a method for computing principal components in order to perform a change of basis on the data, commonly used to reduce the number of features entering a machine learning model by keeping only the first few principal components and ignoring the rest.

An embodiment performs model deployment setup operations within the database system environment. In particular, an embodiment configures a database system environment to allow creation and use of a user defined function (UDF). A UDF is a function provided by the user of a program or environment, in a context where the usual assumption is that functions are built into the program or environment. In a relational database management systems, a UDF extends the functionality of the RDBMS by adding a function, written in a non-SQL programming language, that can be evaluated in standard query language (usually SQL) statements. Once created, a UDF is usable in expressions in SQL statements, for example similarly to the invoking of other intrinsic (i.e., built in rather than user defined) functions. An embodiment also creates a file storage location within the database system environment, and configurates security settings for the file storage location to allow access by a UDF. In one embodiment, the file storage location is a shared directory or folder.

An embodiment validates that integrating the extracted model data, including the model object and model metadata, into a database system environment is allowed within the environment. An embodiment also authenticates the extracted model data. One embodiment authenticates the extracted model data by checking that the file containing the model object and metadata is in the correct format and does not contain security errors. Some non-limiting examples of errors checked for include security issues such as unprotected authentication credentials, cross site scripting, SQL injection, log data that contains sensitive information, and malicious dynamic code. If either of the validation or authentication processes fail, an embodiment rejects deployment of the model within the database system environment. If both the validation and authentication processes pass, deployment of the model within the database system environment is allowed to proceed and an embodiment stores the extracted model data in the already-configured file storage location.

An embodiment integrates the extracted model data into a function executable from within the database system environment. In one embodiment, the function is a user defined function that includes program instructions to deserialize the extracted model data, converting the extracted model data into a format usable in the database system environment. The UDF also includes program instructions to execute the model with a set of input parameters.

An embodiment validates that UDF deployment is authorized. If validation is successful, an embodiment deploys the integrated function within the database system environment, activating the trained model for execution within the database system environment. In an embodiment in which the function is integrated within a UDF, the embodiment registers the UDF with the database system environment. Once the UDF is registered, other database applications and SQL queries can execute the model by calling the UDF. Because the model has now been integrated within the database system environment, model output is now accessible via SQL queries, the model is now controllable via SQL-based tooling, and the model operates on data that remains within the environment.

The manner of machine learning model deployment within a database management system described herein is unavailable in the presently available methods in the technological field of endeavor pertaining to database management systems. A method of an embodiment described herein, when implemented to execute on a device or data processing system, comprises substantial advancement of the functionality of that device or data processing system in extracting model data from a trained model, integrating the model data within a function executable from with a database system environment, and deploying the integrated function within the database system environment, activating the trained model for execution within the database system environment.

The illustrative embodiments are described with respect to certain types of databases, DBMSs, SQL implementations, models, model data, functions, authentications, validations, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

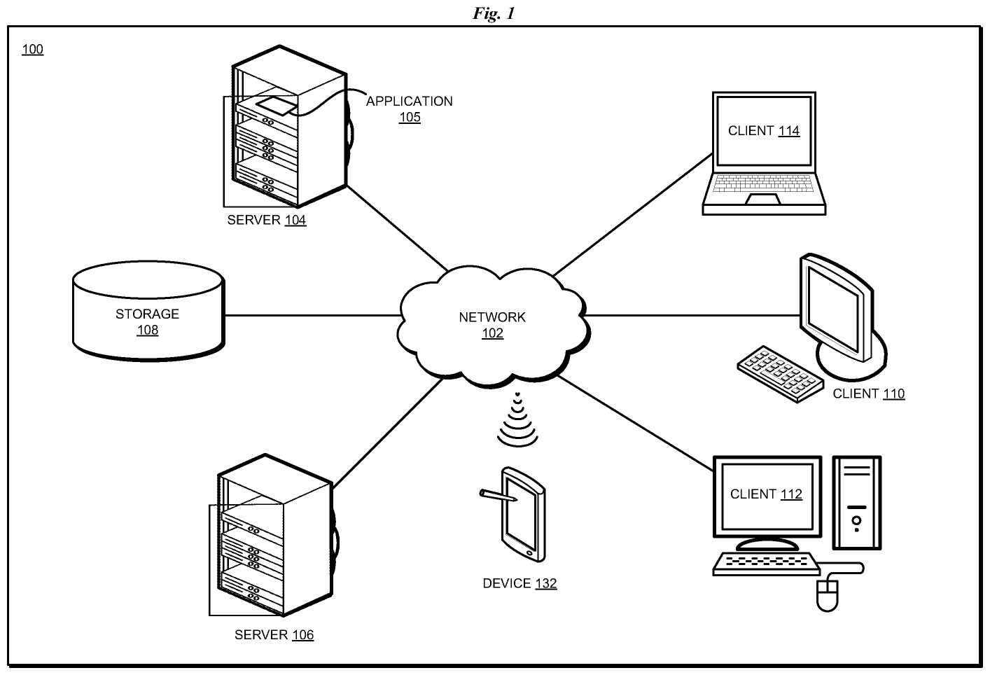

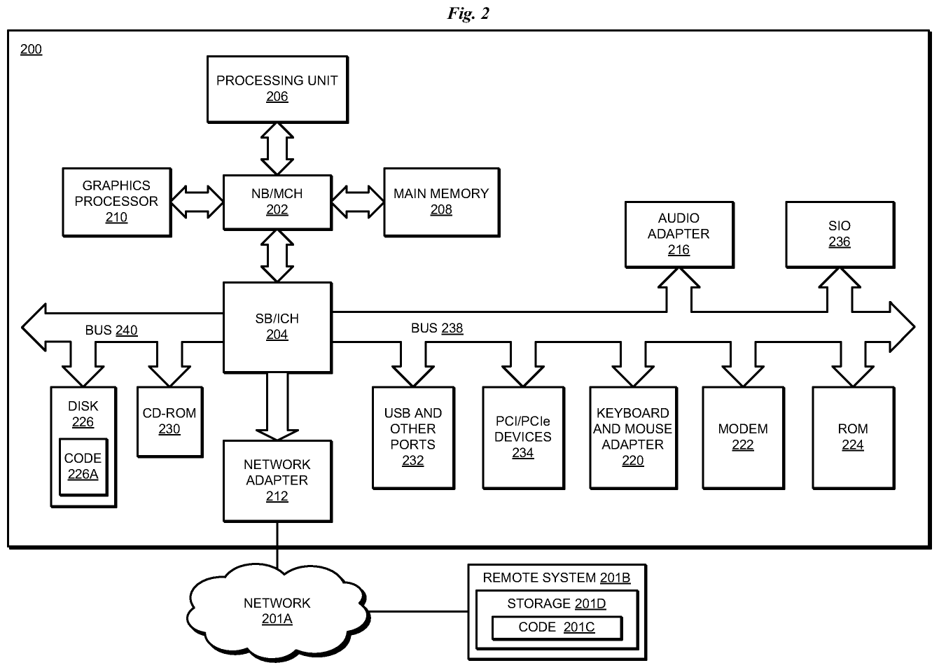

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Application 105 executes in any of servers 104 and 106, clients 110, 112, and 114, and device 132.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

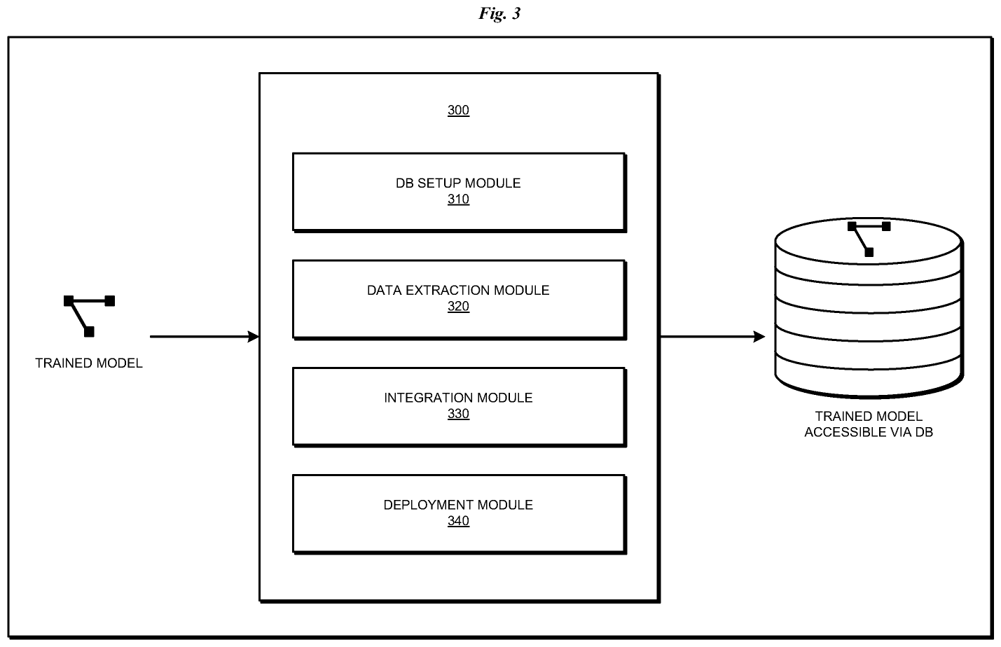

With reference to FIG. 3, this figure depicts a block diagram of an example configuration for machine learning model deployment within a database management system in accordance with an illustrative embodiment. Application 300 is an example of application 105 in FIG. 1 and executes in any of servers 104 and 106, clients 110, 112, and 114, and device 132 in FIG. 1.

Application 300 begins with an already-trained model. One method of generating a trained model is to export a subset of data from a database for use as training and validation data and using the exported data to train and validate the model using any presently available model training technique.

Database setup module 310 configures a database system environment to allow creation and use of a UDF. Module 310 also creates a file storage location within the database system environment, and configurates security settings for the file storage location to allow access by a UDF. In one implementation of module 310, the file storage location is a shared directory or folder.

Data extraction module 320 extracts model data from the already-trained model. The model data is data describing the model sufficiently for model use within a database system environment. The model data includes both the model object, used to generate a score from model inputs, and model metadata, which describes any data pre-processing needed to execute the model object.

Integration module 330 validates that integrating the extracted model data, including the model object and model metadata, into a database system environment is allowed within the environment. Module 330 also authenticates the extracted model data. One implementation of module 330 authenticates the extracted model data by checking that the file containing the model object and metadata is in the correct format and does not contain security errors such as unprotected authentication credentials, cross site scripting, SQL injection, log data that contains sensitive information, and malicious dynamic code. If either of the validation or authentication processes fail, module 330 rejects deployment of the model within the database system environment. If both the validation and authentication processes pass, deployment of the model within the database system environment is allowed to proceed and module 330 stores the extracted model data in the already-configured file storage location.

Module 330 integrates the extracted model data into a function executable from within the database system environment. In one implementation of module 330, the function is a user defined function that includes program instructions to deserialize the extracted model data, converting the extracted model data into a format usable in the database system environment. The UDF also includes program instructions to execute the model with a set of input parameters.

Deployment module 340 validates that UDF deployment is authorized. If validation is successful, module 340 deploys the integrated function within the database system environment, activating the trained model for execution within the database system environment. In an implementation of application 300 in which the function is integrated within a UDF, module 340 registers the UDF with the database system environment. Once the UDF is registered, other database applications and SQL queries can execute the model by calling the UDF. Because the model has now been integrated within the database system environment, users use the model using existing SQL queries and analytical tools and on data that remains within the environment.

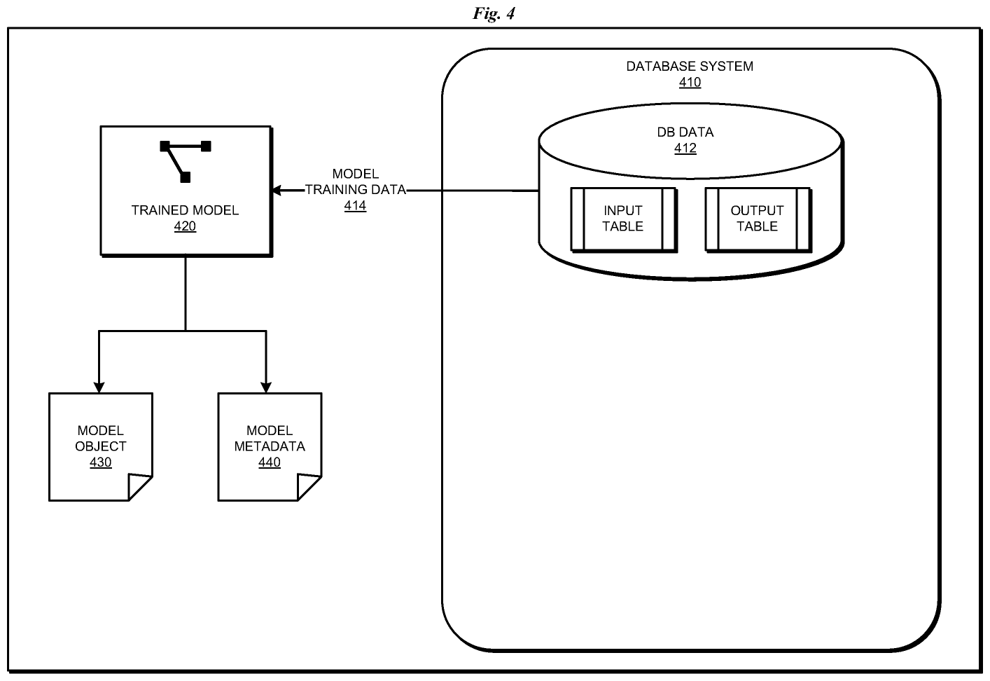

With reference to FIG. 4, this figure depicts an example of machine learning model deployment within a database management system in accordance with an illustrative embodiment. The example can be executed using application 300 in FIG. 3.

Database system 410 includes database data 412. Model training data 414 is exported from database system 410 and used to generate trained model 420. Application 300 extracts model object 430 and model metadata 440 from trained model 420.

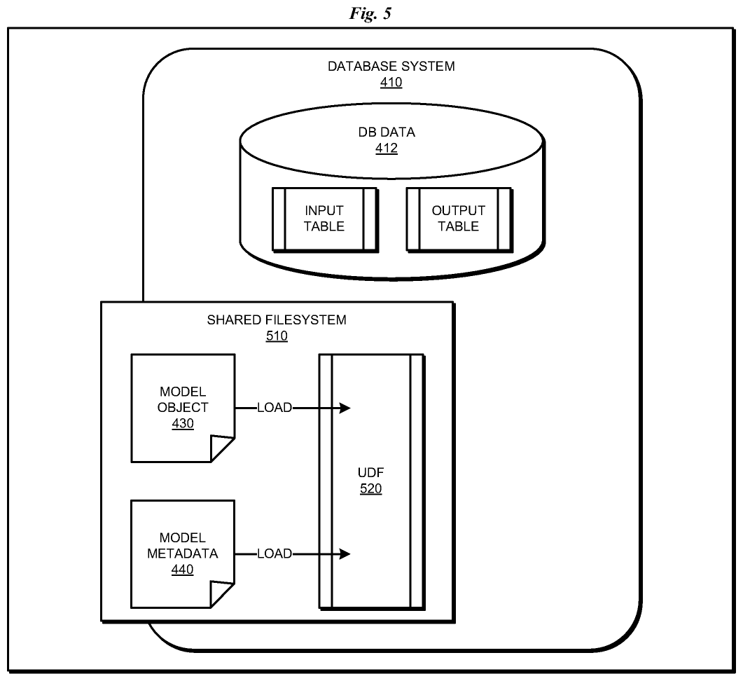

With reference to FIG. 5, this figure depicts a continued example of machine learning model deployment within a database management system in accordance with an illustrative embodiment. Database system 410, database data 412, model object 430, and model metadata 440 are the same as database system 410, database data 412, model object 430, and model metadata 440 in FIG. 4.

As depicted, model object 430 and model metadata 440 are stored in shared filesystem 510, part of database system 410. Model object 430 and model metadata 440 are being integrated into UDF 520, a UDF that includes program instructions to deserialize the extracted model data. UDF 520 also includes program instructions to execute the model with a set of input parameters.

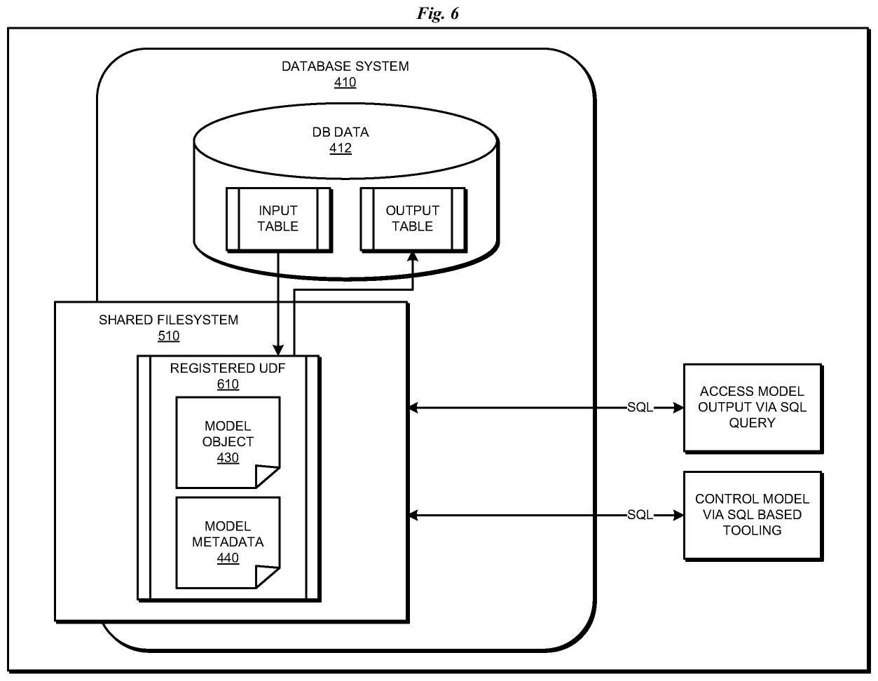

With reference to FIG. 6, this figure depicts a continued example of machine learning model deployment within a database management system in accordance with an illustrative embodiment. Database system 410, database data 412, model object 430, and model metadata 440 are the same as database system 410, database data 412, model object 430, and model metadata 440 in FIG. 4. Shared filesystem 510 is the same as shared filesystem 510 in FIG. 5.

Registered UDF 610, now integrated with model object 430 and model metadata 440, has been deployed within database system 410 and is activated for execution. As a result, other database applications and SQL queries can execute the model by calling the UDF. Because the model has now been integrated within the database system environment, model output is now accessible via SQL queries, the model is now controllable via SQL-based tooling, and the model operates on data that remains within the environment.

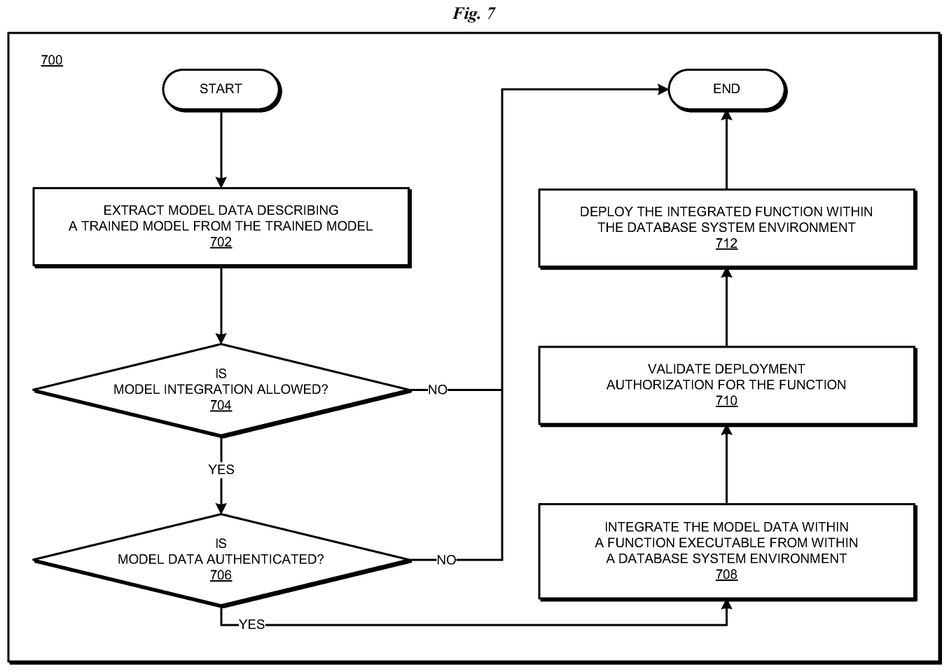

With reference to FIG. 7, this figure depicts a flowchart of an example process for machine learning model deployment within a database management system in accordance with an illustrative embodiment. Process 700 can be implemented in application 300 in FIG. 3.

In block 702, the application extracts model data describing a trained model from the trained model. In block 704, the application determines whether model integration is allowed. If not (“NO” path of block 704), the application ends. Otherwise (“YES” path of block 704), in block 706 the application determines whether model data is authenticated. If not (“NO” path of block 706), the application ends. Otherwise (“YES” path of block 706), in block 708 the application integrates the model data within a function executable from within a database system environment. In block 710, the application validates deployment authorization for the function. In block 712, the application deploys the integrated function within the database system environment. Then the application ends.

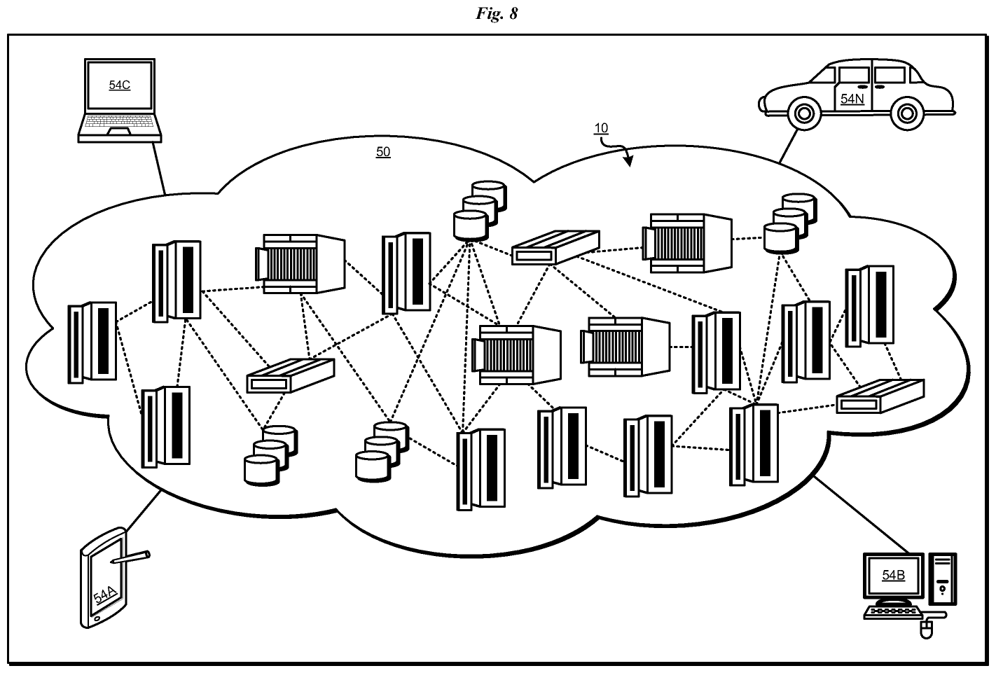

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N depicted are intended to be illustrative only and that computing nodes 10 and cloud computing environment 50 can communicate with any type of computerized device over any type of network and/or network addressable connection (e.g., using a web browser).

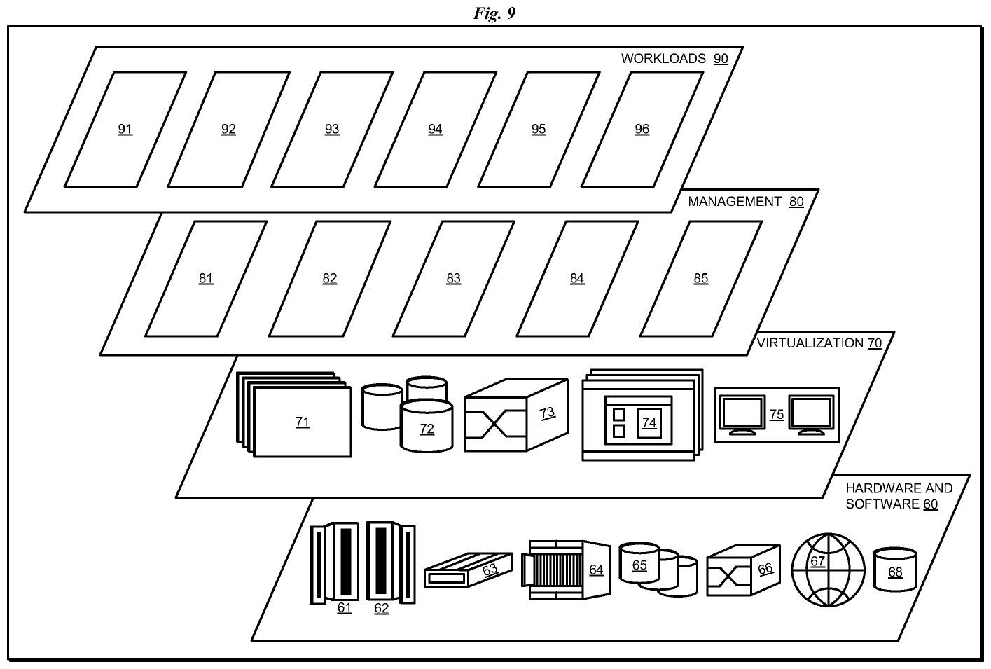

Referring now to FIG. 9, a set of functional abstraction layers provided by cloud computing environment 50 (FIG. 8) is shown. It should be understood in advance that the components, layers, and functions depicted are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and application selection based on cumulative vulnerability risk assessment 96.

Thus, a computer implemented method, system or apparatus, and computer program product are provided in the illustrative embodiments for machine learning model deployment within a database management system and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
extracting, from a trained model, model data, the model data comprising a model object and model metadata;
integrating, within a function executable from within a database system environment, the model data; and
deploying, within the database system environment, the integrated function, the deploying activating the trained model for execution within the database system environment.

2. The computer-implemented method of claim 1, wherein the trained model is trained outside the database system environment.

3. The computer-implemented method of claim 1, further comprising:
validating, prior to the integrating, that the integrating is allowed within the database system environment.

4. The computer-implemented method of claim 1, further comprising:
authenticating, prior to the integrating, the model data.

5. The computer-implemented method of claim 1, wherein the integrated function deserializes the model data.

6. The computer-implemented method of claim 5, wherein the integrated function executes the trained model using the deserialized model data.

7. The computer-implemented method of claim 1, further comprising:
validating, prior to the deploying, that the deploying is allowed within the database system environment.

8. A computer program product for model deployment, the computer program product comprising:
one or more computer readable storage media, and program instructions collectively stored on the one or more computer readable storage media, the program instructions comprising:
program instructions to extracting, from a trained model, model data, the model data comprising a model object and model metadata;
program instructions to integrate, within a function executable from within a database system environment, the model data; and
program instructions to deploy, within the database system environment, the integrated function, the deploying activating the trained model for execution within the database system environment.

9. The computer program product of claim 8, wherein the trained model is trained outside the database system environment.

10. The computer program product of claim 8, further comprising:
program instructions to validate, prior to the integrating, that the integrating is allowed within the database system environment.

11. The computer program product of claim 8, further comprising:
program instructions to authenticate, prior to the integrating, the model data.

12. The computer program product of claim 8, wherein the integrated function deserializes the model data.

13. The computer program product of claim 12, wherein the integrated function executes the trained model using the deserialized model data.

14. The computer program product of claim 8, further comprising:
program instructions to validate, prior to the deploying, that the deploying is allowed within the database system environment.

15. The computer program product of claim 8, wherein the stored program instructions are stored in the at least one of the one or more storage media of a local data processing system, and wherein the stored program instructions are transferred over a network from a remote data processing system.

16. The computer program product of claim 8, wherein the stored program instructions are stored in the at least one of the one or more storage media of a server data processing system, and wherein the stored program instructions are downloaded over a network to a remote data processing system for use in a computer readable storage device associated with the remote data processing system.

17. The computer program product of claim 8, wherein the computer program product is provided as a service in a cloud environment.

18. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to extracting, from a trained model, model data, the model data comprising a model object and model metadata;
program instructions to integrate, within a function executable from within a database system environment, the model data; and
program instructions to deploy, within the database system environment, the integrated function, the deploying activating the trained model for execution within the database system environment.

19. The computer system of claim 18, wherein the trained model is trained outside the database system environment.

20. The computer system of claim 18, further comprising:
program instructions to validate, prior to the integrating, that the integrating is allowed within the database system environment.
